(19) United States
(12) Patent Application Publication
(10) Pub. No.: US 2009/0019762 A1
(43) Pub. Date: Jan. 22, 2009

(54) Monofilament Line Straightening Device, and Monofilament Line Straightening Method

(76) Inventor: Yoshimune Takahashi, Saitama (JP)

Correspondence Address: MARJAMA MULDOON BLASIAK & SULLIVAN LLP, 250 SOUTH CLINTON STREET, SUITE 300, SYRACUSE, NY, 13202, US

(21) Appl. No.: 12/223,425

(22) PCT Filed: Feb. 1, 2006
(86) PCT No.: PCT/JP2006/301697

§ 371 Date: Jul. 30, 2008

(51) Int. Cl. A01K 97/00

(52) U.S. Cl. 43/44.98; 392/417

(57) ABSTRACT

A monofilament line straightening device and a monofilament line straightening method according to the present invention perform steam blow and/or pressing using a heated trowel member to a monofilament line in the state where its tension is loosened by a predetermined amount relative to the state where it is suspended without being loosened, thereby removing curls in the monofilament line. Thus, a reduction in the line strength which might occur when removing the curls in the monofilament line by heating can be suppressed.

### CROSS REFERENCE TO RELATED APPLICATIONS

This application is a National Stage filing under 35 U.S.C. §371 of PCT Application No. PCT/JP2006/301697, filed Feb. 1, 2006, published in Japanese. The above application is incorporated by reference herein.

### TECHNICAL FIELD

The present invention relates to a monofilament line straightening device and a monofilament line straightening method, and more particularly, to those for removing curls in a monofilament line by heating the same.

### BACKGROUND ART

Since chemically-synthesized monofilament lines comprising materials such as nylon, polyester, polyamide, and fluorocarbon, which are generally marketed as fishing lines or the like, are packed being wound around cylindrical bobbins or being hauled into circular loops, these lines have undesirable curls. Removing such curls is a major challenge for fishing lovers and those involved in fishery.

So, means for removing such curls in monofilament lines have previously been proposed. For example, Japanese Patent No. 3265305 discloses a method for, utilizing that a chemically-synthesized monofilament line is moderately softened when heated, removing curls of the monofilament line to straighten the same by heating the line in its tensioned and suspended state so as not to be loosened.

FIG. 4(a) is a plan view illustrating the conventional monofilament line straightening device, and FIG. 4(b) is a partial side view thereof.

As shown in the figures, the monofilament line straightening device 400 has, as its main body, a worktable 101 having an air permeable structure. A cloth member 101a such as felt is attached to the surface of the worktable 101. Line pressing members 102a and 102b are fixed to the surface of the worktable 101, and pulleys 104a and 104b are provided thereon. The line pressing members 102a and 102b have tapered portions at their surfaces contacting the cloth member 101a, respectively.

Further, the pulleys 104a and 104b are mounted rotatably by center bearings (not shown) on the line pressing members 102 via washers 105, respectively. The pulley 104a and the line pressing member 102a as well as the pulley 104b and the line pressing member 102b are fixed via the washers 105 to predetermined positions on the worktable 101 by wing screws 103a and 103b, respectively.

Next, a description will be given of how to use this fishing line straightening device 400.

Initially, an end of the fishing line 110 is fixed using the line pressing member 102a, and the fishing line 110 of a desired length is wound around the two pulleys 104a and 104b many times, and then the other end of the fishing line 110 is fixed using the line pressing member 102b.

Next, portions of the fishing line 110 between the adjacent line pressing members 102a and 102b are heated using a heated trowel member such as an iron while blowing steam thereto.

When this first heat treatment is finished, the fishing line 110 is moved by rotating the pulleys 104a and 104b so that the portions of the fishing line 110 which are placed under the respective line pressing members 102a and 102b and were not subjected to the heat treatment, as well as the unheated portions thereof on the pulleys 104a and 104b are positioned between the adjacent line pressing members.

Thereafter, the portions of the fishing line 110 which were placed under the line pressing members 102a and 102b and not subjected to the first heat treatment as well as the unheated portions thereof on the pulleys 104a and 104b are heated using an iron or the like while blowing steam thereto in the same manner as described above.

When this second heat treatment is finished, the fishing line 110 fixed by the line pressing members 102a and 102b is detached, thereby obtaining the fishing line 110 of the desired length from which the curls are removed.

In the conventional fishing line straightening method, however, since the heat treatment is performed with the monofilament line being suspended in its tensioned state, the monofilament line might be deteriorated due to the heat, which leads to a reduction in the line strength.

The present invention is made to solve the above-described problems and has for its object to provide a monofilament line straightening device and a monofilament line straightening method which can suppress a reduction in the line strength that might occur when removing curls in the monofilament line by heating the same.

Patent Document 1: Japanese Patent No. 3265305

### DISCLOSURE OF THE INVENTION

According to Claim 1 of the present invention, there is provided a monofilament line straightening device for removing curls in a monofilament line by performing a steam blow or a press work using a heated trowel member to the monofilament line, comprising: a worktable having a flat surface; two line fixing members for suspending and fixing the monofilament line, which are provided at two positions on the worktable; a moving mechanism which makes either of the two line fixing members movable in a direction along which the monofilament line is tensioned or in the opposite direction; and markers serving as indicators for the moving amount of the line fixing member that is made movable, which are provided on the worktable.

Thereby, by performing the steam blow and/or the press work using a heated trowel member after the line fixing member is moved by a predetermined amount based on the markers so as to loosen the tension of the monofilament line from the state where it is tensioned and suspended, the monofilament line is contracted to increase its diameter during the heat treatment, and thus a reduction in the line strength which might occur when removing the curls in the monofilament line by heating can be suppressed.

According to Claim 2 of the present invention, there is provided a monofilament line straightening device for removing curls in a monofilament line by performing a steam blow or a press work using a heated trowel member to the monofilament line, comprising: a worktable having a flat surface; two line fixing members around which the monofilament line is wound, which are provided at two positions on the worktable; a moving mechanism which makes either of the two line fixing members movable in a direction along which the monofilament line is tensioned or in the opposite direction; and an urging means which, with its one end being latched to the line fixing member that is made movable, urges the line fixing member that is made movable, toward a direction along which the monofilament line that is wound around the two line fixing members is tensioned.

Thereby, the monofilament line is contracted to increase its diameter, with remaining its tensioned and suspended state, when it is subjected to the steam blow and/or the press work using a heated trowel member, and thus a reduction in the line strength which might occur when removing the curls in the monofilament line by heating can be suppressed more easily.

According to Claim 3 of the present invention, there is provided a monofilament line straightening method for removing curls in a monofilament line by performing a steam blow or a press work using a heated trowel member to the monofilament line, comprising: winding the monofilament line around two line fixing members; moving either of the two line fixing members by an amount within a range of contraction of the monofilament line after performing the steam blow or the press work using the heated trowel member; and performing a steam blow or a press work using a heated trowel member to the monofilament line in its tension-loosened state, which is wound around the two line fixing members.

Thereby, the monofilament line is contracted to increase its diameter when it is subjected to the steam blow and/or the press work using a heated trowel member, and thus a reduction in the line strength which might occur when removing the curls in the monofilament line by heating can be suppressed.

According to Claim 4 of the present invention, there is provided a monofilament line straightening method for removing curls in a monofilament line by performing a steam blow or a press work using a heated trowel member to the monofilament line, comprising: winding the monofilament line around two line fixing members; performing a steam blow or a press work using a heated trowel member to the monofilament line suspended between the two line fixing members; and moving either of the two line fixing members by a contraction force that is possessed by the monofilament line after performing the steam blow or the press work using the heated trowel member so as to maintain the tension of the monofilament line which is suspended between the two line fixing members constant.

Thereby, the monofilament line is contracted to increase its diameter, with remaining its tensioned and suspended state, when it is subjected to the steam blow and/or the press work using a heated trowel member, and thus a reduction in the line strength which might occur when removing the curls in the monofilament line by heating can be suppressed more easily.

### BRIEF DESCRIPTION OF THE DRAWINGS

FIG. 1(a) is a plan view illustrating a monofilament line straightening device according to a first embodiment of the present invention,

FIG. 1(b) is a partial side view of the monofilament line straightening device according to the first embodiment.

FIG. 1(c) is a partial cross-sectional view of the monofilament line straightening device according to the first embodiment.

FIG. 2(a) is a plan view for explaining the operation of pulleys when executing a monofilament line straightening method according to the first embodiment.

FIG. 2(b) is a side view for explaining the operation of the pulleys when executing the monofilament line straightening method according to the first embodiment.

FIG. 3(a) is a plan view illustrating a monofilament line straightening device according to a second embodiment of the present invention.

FIG. 3(b) is a partial cross-sectional view of the monofilament line straightening device according to the second embodiment.

FIG. 4(a) is a plan view illustrating the conventional monofilament line straightening device.

FIG. 4(b) is a partial side view of the conventional monofilament line straightening device.

### BEST MODE TO EXECUTE THE INVENTION

Hereinafter, embodiments of the present invention will be described with reference to the drawings.

### Embodiment 1

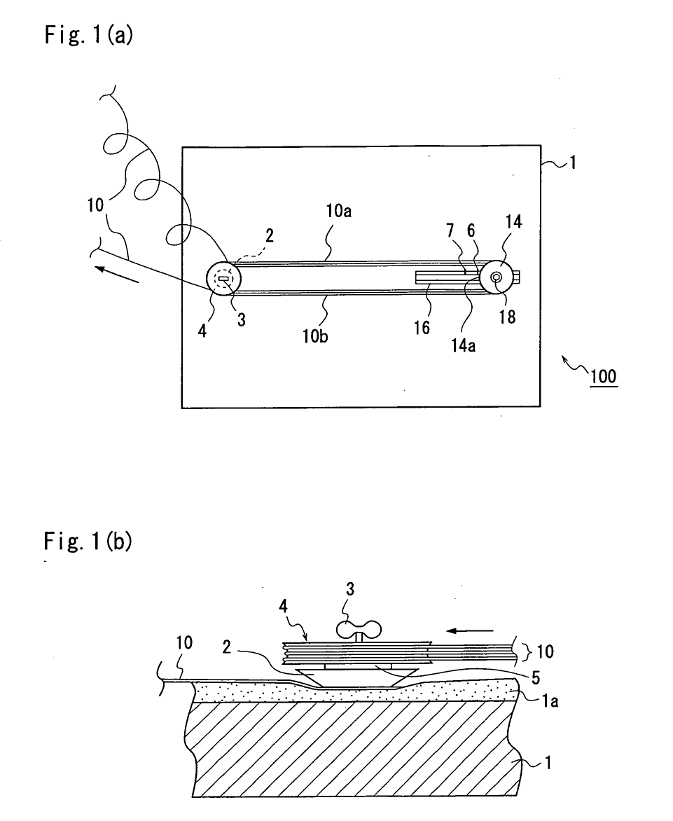

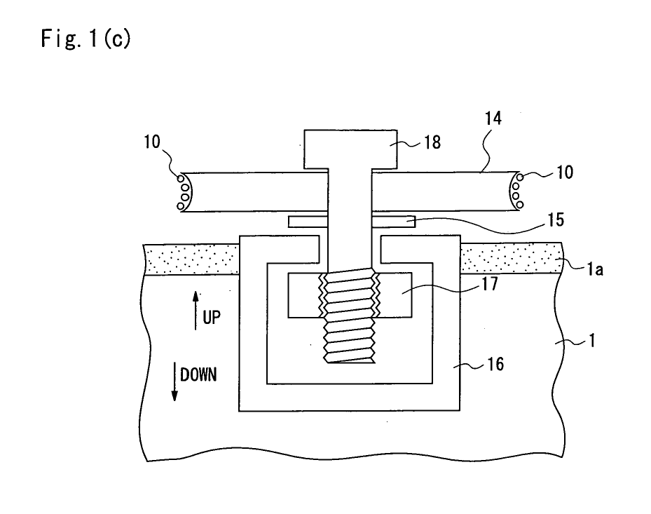

FIG. 1(a) is a plan view illustrating a monofilament line straightening device according to a first embodiment of the present invention, FIG. 1(b) is a partial side view thereof, and FIG. 1(c) is a partial cross-sectional view thereof.

As shown in FIG. 1(a), the monofilament line straightening device 100 of this first embodiment has, as its main body, a worktable 1 having an air permeable structure, and a cloth member 1a such as felt is attached to the surface of the worktable 1.

As shown in FIG. 1(b), a line pressing member 2, a washer 5, and a first pulley 4 are fixed to a predetermined position on the worktable 1 by a wing screw 3 at an end of the surface of the worktable 1.

The line pressing member 2 has, at the surface contacting the cloth member 1a, a tapered portion which facilitates fixing of the monofilament line 10. As a material of the line pressing member 2, a metal, a synthetic resin, a hard rubber, or the like may be used. The first pulley 4 is a member for hanging the monofilament line 10, and it has a bearing (not shown) in its center so as to be rotatable around the wing screw 3.

Further, a rail member 16 having an approximately U-shaped cross section, which is made of a material such as aluminum or stainless steel, is embedded at the surface of the worktable 1. As shown in FIG. 1(c), a nut 17 having a shape at least two sides of which contact the side walls of the groove, e.g., a rectangle, is inserted in the groove of the rail member 16, and a second pulley 14 is axially supported via a washer 15 by a bolt 18 such as a hexagon bolt which is screwed to the nut 17. The second pulley 14 can be moved to an arbitrary position on the rail member 16 by loosening this bolt 18, and the second pulley 14 can be fixed to the worktable 1 against the rail member 16.

Further, as shown in FIG. 1(a), markers 6 and 7 are provided on the rail member 16 in the descending order of distance from the first pulley 4.

Next, a description will be given of a monofilament line straightening method using the monofilament line straightening device 100 of the first embodiment.

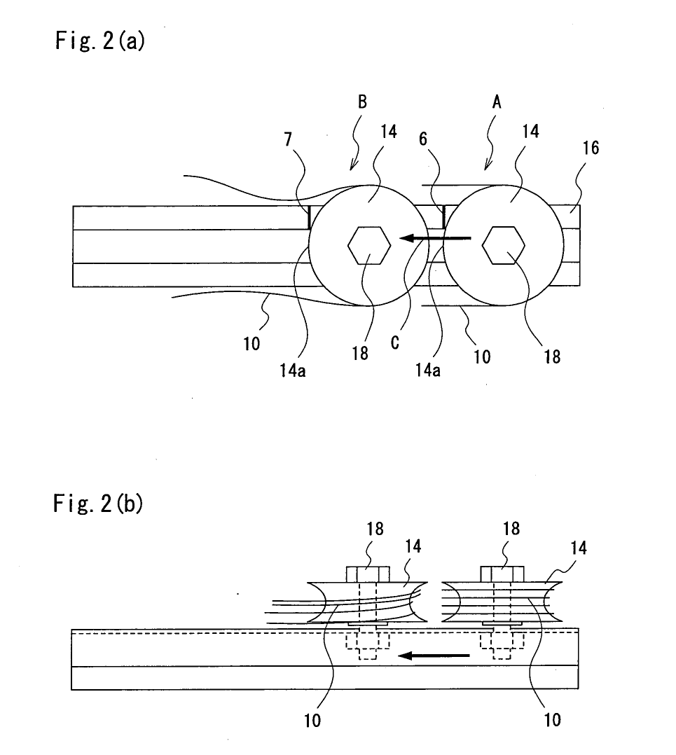

FIG. 2(a) is a plan view illustrating the second pulley 14 and the state of the monofilament line 10 when executing the monofilament line straightening method of the first embodiment, and FIG. 2(b) is a side view thereof.

Next, a description will be given of the operation of removing curls in the monofilament line using the monofilament line straightening device of the first embodiment.

Initially, when performing the work of removing curls in the fishing line, in the state shown in FIG. 1(a), the bolt 18 is loosened, and the second pulley 14 is moved to a position where its peripheral end part 14a at the inner side is aligned with the marker 6, and the bolt 18 is rotated rightward in this state. Then, the nut 17 which is engaged with the bolt 18 moves upward in the rail member 16 with the rotation of the bolt 18, and the upper surface of the nut 17 contacts the upper surface of the rail member 16, and thereby the second pulley 14 is fixed at the above-described position to the rail member 16 via the washer 15.

Next, the fishing line that is packed being wound on a cylindrical bobbin or the like is let out by a desired length, and sandwiched to be fixed between the line pressing member 2 and the cloth member 1a on the surface of the worktable 1. Then, the let-out monofilament line 10 is wound many times between the pulleys 4 and 14 to obtain the state shown in FIG. 1(a).

Thereafter, the bolt 18 is loosened, and the second pulley 14 is slid as shown by an arrow C until its peripheral end part 14a at the inner side comes to the position of the marker 7. That is, in FIGS. 2(a) and 2(b), the second pulley 14 is moved from the position A to the position B.

At this time, the tension of the monofilament line 10 is loosened as shown in the position B in FIGS. 2(a) and 2(b), and in this state, the bolt 18 is fastened to fix the second pulley 14.

Then, portions 10a and 10b to be subjected to heat treatment of the monofilament line 10 that is suspended between the first and second pulleys 4 and 14 are heated by pressing a heated trowel member such as a steam iron against these portions while blowing steam thereto.

Since generally the chemically-synthesized monofilament comprising a material such as nylon, polyester, polyamide, or fluorocarbon is moderately softened when heated, the temperature of the steam iron or the like is set to a low level (about 140□).

While the monofilament line 10 after the heating would be contracted by a predetermined amount according to the temperature of the heating trowel member and the heating time when it returns to the room temperature, the marker 7 is provided at a desired position according to the thickness of the monofilament line 10, the temperature of the heating trowel member, and the heating time so that the monofilament line 10 would be in its tensioned and suspended state when it is fully contracted. Therefore, the monofilament line 10 that is fixed between the first and second pulleys 4 and 14 in its loosened state is, after the heat treatment, cooled by the air to be contracted until it goes into the tensioned and suspended state, and the curls in the monofilament line 10 are removed by this heating and cooling.

After the first heat treatment is finished, the both pulleys 4 and 14 are rotated to move the monofilament line 10 so that the portions of the monofilament line 10 which are pressed under the line pressing members 2 and were not subjected to the heat treatment, as well as the unheated portions thereof on the pulleys 4 and 14 are positioned between the first pulley 4 and the second pulley 14, and then a heat treatment is performed in the same manner as described above to the portions of the monofilament line 10 between the both pulleys 4 and 14, including the portions which were not subjected to the first heat treatment.

After this second heat treatment, the monofilament line 10 fixed between the both pulleys 4 and 14 is cooled by the air to be contracted until it goes into the tensioned and suspended state. By this heating and cooling, also the portions of the monofilament line 10 which were placed under the line pressing members 2 of the pulleys 4 and 14 during the first heat treatment are straightened, and thus the line strength is increased.

After the second heat treatment is finished, the bolt 18 of the right-side pulley 14 is loosened, and the monofilament line suspended between the pulleys 4 and 14 is detached from the pulleys, thereby obtaining the monofilament line 10 from which the curls are removed.

As described above, according to the monofilament line straightening device of this first embodiment, after the monofilament line is suspended in its tensioned state by winding the same around the two pulleys, the heat treatment is performed in the state where the monofilament line is loosened by sliding the pulley by a predetermined amount using the marker positions provided on the rail member, and then the monofilament line is cooled to be contracted by the air. Thereby, the diameter of the monofilament line as well as the strength thereof are increased due to the contraction of the monofilament line after the heat treatment, and thus a reduction in the line strength which has conventionally occurred when removing the curls in the monofilament line by heating can be suppressed.

While in this first embodiment the markers are provided on the rail member, the present invention is not restricted thereto. The markers may be provided at any positions which can be the indicators for the sliding amount of the pulley, such as on the worktable. Further, the positions of the markers may be set within the range of the contraction of the monofilament line, with considering the relationships among the thickness of the monofilament line, the temperature of the heating trowel member, and the heating time.

While in this first embodiment the markers are provided at the position where the monofilament line is suspended in its tensioned state and at the position where the tension of the suspended monofilament line is loosened, respectively, scales may be merely provided to be used as indicators for loosening the tension of the monofilament line.

Further, in the monofilament line straightening device of the present invention, the number of the pulleys is not restricted to two, and the device may be provided with at least one pulley which can be moved by the rail member.

Furthermore, the location of the line pressing member 2 is not restricted to under the pulley 4, and it may be provided at an arbitrary position on the worktable 1.

### Embodiment 2

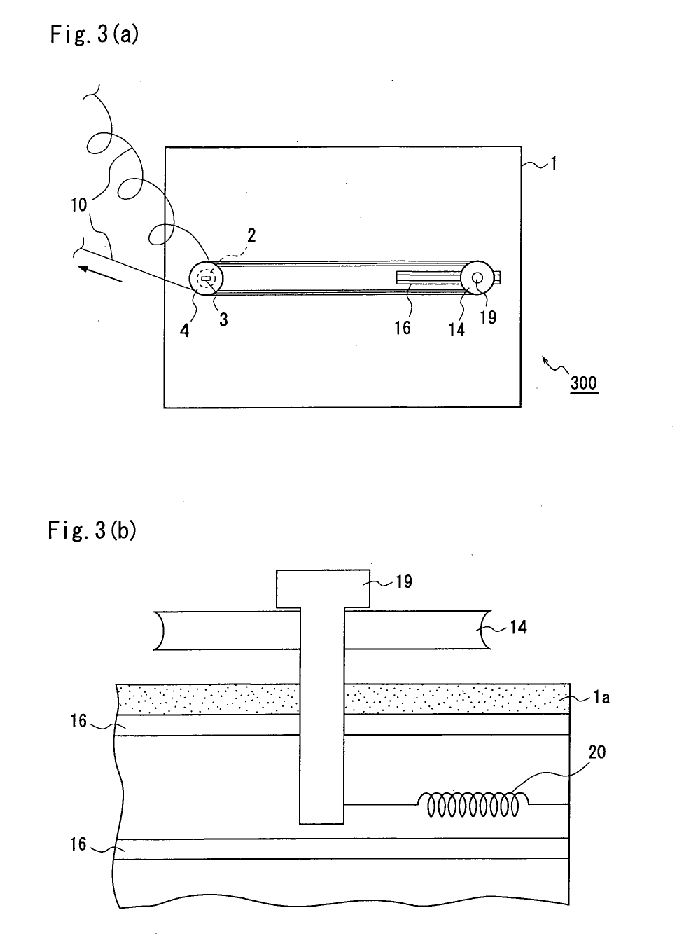

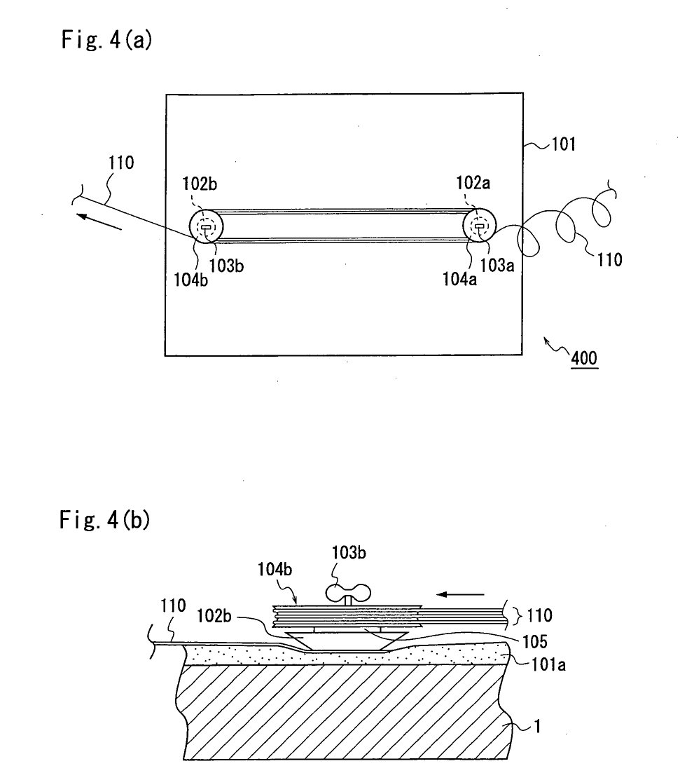

FIG. 3(a) is a plan view illustrating a monofilament line straightening device according to a second embodiment of the present invention, and FIG. 3(b) is a partial cross-sectional view thereof. In these figures, the same constituents as those shown in FIGS. 1(a) to 1(c) are given the same reference numerals.

As shown in FIG. 3(b), the monofilament line straightening device 300 of this second embodiment includes an axial member 19 which axially supports the second pulley 14, and a lower end of the axial member 19 is inserted in the groove of the rail member 16. The device 300 further includes a tension spring 20 which, having one end attached to the lower end part of the axial member 19 and the other end attached to the worktable, urges the second pulley 14 in a direction along which the first pulley 4 and the second pulley 14 are apart from each other when the monofilament line is suspended between the first and second pulleys 4 and 14. The urging force of the tension spring 20 is previously set to an optimum value based on the contraction characteristics or the like of the monofilament line to be straightened.

Next, a description will be given of the monofilament line straightening method using the monofilament line straightening device 300 of the second embodiment.

Initially, the monofilament line 10 is wound between the both pulleys 4 and 14 as shown in FIG. 1(a) in like manner as described for the first embodiment.

Next, portions 10a and 10b of the monofilament line 10 between the first pulley 4 and the second pulley 14 are heated by pressing a heated trowel member such as a steam iron against the portions while blowing steam thereto.

When the steam iron is separated from the monofilament line 10 after the heat treatment, contraction occurs in the monofilament line 10, and the second pulley 14 is pulled toward the first pulley 4 by the contraction force, and thereby the tension spring 20 expands. Thereby, the monofilament line 10 is contracted in its tensioned state, and thus the curls are removed.

After the first heat treatment is finished, the both pulleys 4 and 14 are rotated to move the monofilament line 10 so that the portions of the monofilament line 10 which are positioned under the respective line pressing members 2 and were not subjected to the heat treatment, as well as the unheated portions thereof on the pulleys 104a and 104b are positioned between the pulleys 4 and 14, and then a heat treatment is performed in the same manner as described above to the portions of the monofilament line 10 between the both pulleys 4 and 14, including the portions which were not subjected to the first heat treatment.

After this second heat treatment, the monofilament line 10 fixed between the both pulleys 4 and 14 is cooled by the air to be contracted until it goes into the tensioned and suspended state. By this heating and cooling, also the portions which were positioned under the line pressing members 2 of the pulleys 4 and 14 during the first heat treatment are straightened.

After the second heat treatment is finished, the bolt 18 of the right-side pulley 14 is loosened, and the monofilament line suspended between the pulleys 4 and 14 is detached from the pulleys, thereby obtaining the monofilament line 10 from which the curls are removed.

As described above, the monofilament line straightening device of this second embodiment is provided with the tension spring which urges the pulley toward the direction along which the monofilament line is tensioned. Thereby, the diameter of the monofilament line as well as the strength thereof are increased by its contraction after the heat treatment, and thus a reduction in the line strength which has conventionally occurred when removing the curls from the monofilament line by heat treatment can be suppressed, and moreover, the operation of removing the curls in the monofilament line can be performed more easily.

While in this second embodiment the tension spring is used to urge the second pulley 14, the present invention is not restricted thereto. A compression spring, a rubber, or a cylinder using air pressure or oil pressure may be used.

Further, the location of the line pressing member 2 is not restricted to under the pulley 4, and it may provided at an arbitrary position on the worktable 1.

Further, while in the first and second embodiments the monofilament line is heated by pressing the heated trowel member while blowing steam to the same, it may be heated by only either of the heating by steam blow or the heating using the heated trowel member.

Furthermore, while in the first and second embodiments only either of the two pulleys is made slidable, both of the pulleys may be made slidable.

### APPLICABILITY IN INDUSTRY

Since the present invention can suppress a reduction in the line strength which might occur when removing curls in the monofilament line by heating, it is useful as a device for straightening a fishing line or the like.

1. A monofilament line straightening device for removing curls in a monofilament line by performing a steam blow or a press work using a heated trowel member to the monofilament line, said device comprising:
a worktable having a flat surface;
two line fixing members for suspending and fixing the monofilament line, which are provided at two positions on the worktable;
a moving mechanism which makes either of the two line fixing members movable in a direction along which the monofilament line is tensioned or in the opposite direction; and
markers serving as indicators for the moving amount of the line fixing member that is made movable, which are provided on the worktable, and
said markers being provided at predetermined positions so that the monofilament line is contracted and suspended in its tensioned state when the monofilament line that is wound over the two line fixing members is subjected to the heat treatment.

2. A monofilament line straightening device for removing curls in a monofilament line by performing a steam blow or a press work using a heated trowel member to the monofilament line, said device comprising:
a worktable having a flat surface;
two line fixing members around which the monofilament line is wound, which are provided at two positions on the worktable;
a moving mechanism which makes either of the two line fixing members movable in a direction along which the monofilament line is tensioned or in the opposite direction; and
an urging means which, with its one end being latched to the line fixing member that is made movable, urges the line fixing member that is made movable, toward a direction along which the monofilament line that is wound around the two line fixing members is tensioned.

3. A monofilament line straightening method for removing curls in a monofilament line by performing a steam blow or a press work using a heated trowel member to the monofilament line, said method comprising:
winding the monofilament line around two line fixing members;
moving either of the two line fixing members by an amount within a range of contraction of the monofilament line after performing the steam blow or the press work using the heated trowel member; and
performing a steam blow or a press work using a heated trowel member to the monofilament line in its tension-loosened state, which is wound around the two line fixing members.

4. A monofilament line straightening method for removing curls in a monofilament line by performing a steam blow or a press work using a heated trowel member to the monofilament line, said method comprising:
winding the monofilament line around two line fixing members;
performing a steam blow or a press work using a heated trowel member to the monofilament line suspended between the two line fixing members; and
moving either of the two line fixing members by a contraction force that is possessed by the monofilament line after performing the steam blow or the press work using the heated trowel member so as to maintain the tension of the monofilament line which is suspended between the two line fixing members constant.
